(19) United States
(12) Patent Application Publication
(10) Pub. No.: US 2025/0042342 A1
(43) Pub. Date: Feb. 6, 2025

(54) Bicycle Carrier

(71) Applicant: Kuat Innovations LLC, Springfield, MO (US)

(72) Inventors: Austin Harrill, Springfield, MO (US); Luke Kuschmeader, Springfield, MO (US); Aaron Houston, Springfield, MO (US); Jonathan Graif, Springfield, MO (US)

(73) Assignee: Kuat Innovations LLC, Springfield, MO (US)

(21) Appl. No.: 18/785,794

(22) Filed: Jul. 26, 2024

Related U.S. Application Data
(60) Provisional application No. 63/516,710, filed on Jul. 31, 2023.

(51) Int. Cl. B60R 9/10; B60R 9/06

(52) U.S. Cl. CPC B60R 9/10; B60R 9/06

(57) ABSTRACT

A bicycle carrier for an automobile comprises a platform for supporting the wheels of a bicycle and a wheel securement arm attached to the platform. The wheel securement arm can be pivotally attached to the platform to secure a wheel of a bicycle on the platform. A control arm can be attached to the platform and the wheel securement arm to releasably fix the wheel securement arm in a desired position with respect to the platform. The control arm can be slidably connected to the wheel securement arm to modify the position of the wheel securement arm. The desired position of the wheel securement arm can be with a portion of the wheel securement arm in contact with the tire of a bicycle or it can be with the wheel securement arm folded against the platform.

### BACKGROUND

### Field of the Invention

This disclosure is in the field of bicycle carriers for automobiles. More specifically, this disclosure is in the field of bicycle carriers for electric bicycles, small motorcycles, or heavy bicycles. More specifically, this disclosure is in the field of bicycle carriers that clamp a tire or wheel of a bicycle between a wheel securement arm and a platform, or between a wheel securement arm and an additional support member such as a tire chock.

Parts of this disclosure are in the field of bicycle ramps for bicycle carriers. More specifically, these parts of the disclosure are in the field of extrusions and components for providing internal storage for a bicycle ramp in a bicycle carrier.

Parts of this disclosure are in the field of mechanisms for securing a wheel securement arm in a desired position such as to secure a bicycle tire on a bicycle carrier. More specifically, these parts of the disclosure are in the field of improved latching mechanisms for preventing the wheel securement arm from rotating away from the wheel of a bicycle that is secured on the bicycle carrier.

### SUMMARY OF THE INVENTION

Embodiments of the inventive bicycle carrier claimed in this application include a bicycle carrier comprising a platform configured to support a bicycle tire; a wheel securement arm pivotally attached to the platform, wherein a portion of the wheel securement arm comprises a ratchet rack; a control arm pivotally connected at a first end thereof to the platform, a latch body slidably disposed on the wheel securement arm; a ratchet pawl pivotally disposed on the latch body and configured to engage the ratchet rack to prevent translation of the latch body on the wheel securement arm in a first direction; wherein the control arm is pivotally connected at a second end thereof to the latch body. In some embodiments of the bicycle carrier the ratchet rack comprises a plurality of indentations formed in the body of the wheel securement arm.

Some embodiments of the bicycle carrier further comprise a trigger attached to the ratchet pawl; the trigger configured to disengage the ratchet pawl from the ratchet rack. In some of these embodiments of the bicycle carrier the trigger is pivotally attached to the latch body. In other embodiments of the bicycle carrier the latch body further comprises a handle portion configured to be gripped by a user. In some of these embodiments of the bicycle carrier the trigger pivots to a position adjacent to the handle to disengage the ratchet pawl from the ratchet rack. In some of these embodiments the trigger further comprises a handle portion configured to be gripped by a user.

In some embodiments of the bicycle carrier sliding the latch body in the first direction pivots the wheel securement arm to an open position for receiving a bicycle tire. In these embodiments sliding the latch body in a direction opposite the first direction pivots the wheel securement arm to a closed position adjacent to the platform. In some of these embodiments, the first direction is oriented along the length of the wheel securement arm extending toward the attachment of the wheel securement arm to the platform. In some claimed embodiments of the bicycle carrier the ratchet rack extends along the wheel securement arm to engage the ratchet pawl when the wheel securement arm is in both the open position and the closed position.

In various other embodiments, the inventive bicycle carrier comprises a platform configured to support a bicycle tire; a wheel securement arm pivotally attached to the platform; a back-side tire chock assembly disposed on the tire platform, the back-side tire chock assembly comprising a tire chock member and a support arm; and a guide slot fixed in relation to the tire platform; wherein the tire chock member is pivotally attached to the tire platform; wherein a first end of the support arm is pivotally attached to the tire chock member, and a second end of the support arm is slidably captured in the guide slot between a deployed configuration and a stowed configuration; and wherein the biasing mechanism is configured to translate the support arm to the deployed position.

In some embodiments the bicycle carrier further comprises a biasing mechanism configured to translate the support arm to the deployed position. In some embodiments of the bicycle carrier, the support arm, the tire platform, and the platform form an acute triangle in the deployed configuration. In some embodiments the biasing mechanism comprises a torsion spring.

Other embodiments of the inventive bicycle carrier further comprise a stowing handle in contact with the support arm and slidably disposed on the platform. In some embodiments of the bicycle carrier, the second end of the support arm contacts an end of the guide slot in the deployed configuration.

### BRIEF DESCRIPTION OF THE DRAWINGS

FIG. 1A is a perspective view of an embodiment of the inventive bicycle carrier with a ramp in a deployed configuration.

FIG. 1B is a detail perspective view of an embodiment of the inventive bicycle carrier with a ramp in a deployed configuration.

FIG. 1C is a detail perspective view of an embodiment of the inventive bicycle carrier with a ramp in a stowed configuration.

FIG. 1D is a detail cross-sectional view of a portion of an embodiment of the inventive bicycle carrier with a ramp in a stowed configuration.

FIG. 1E is a detail cross-sectional view of a portion of an embodiment of the inventive bicycle carrier with a ramp removed from the carrier.

FIG. 1F is a detail cross-sectional view of a portion of an embodiment of the inventive bicycle carrier with a ramp in a deployed configuration.

FIG. 1G is a detail side perspective view of a portion of an embodiment of the inventive bicycle carrier with a ramp in a deployed configuration.

FIG. 1H is a detail perspective view of a first end portion of a ramp of an embodiment of the inventive bicycle carrier.

FIG. 1I is a detail bottom perspective view of a first end portion of a ramp of an embodiment of the inventive bicycle carrier.

FIG. 1J is a detail top perspective view of a first end portion of a ramp of an embodiment of the inventive bicycle carrier.

FIG. 1K is a detail perspective view of a second end portion of a ramp of an embodiment of the inventive bicycle carrier.

FIG. 2A is a side view of an embodiment of a ratchet arm of the inventive carrier.

FIG. 2B is a detail cross-sectional side view of a portion of an embodiment of a ratchet arm of the inventive carrier in a latched configuration.

FIG. 2C is a detail cross-sectional side view of a portion of a ratchet arm of an embodiment of the inventive carrier in an unlatched configuration.

FIG. 2D is a detail cross-sectional side view of a portion of a ratchet arm of another embodiment of the inventive carrier in an unlatched configuration.

FIG. 3A is a side view of another embodiment of the inventive carrier with a tire chock in a stowed configuration.

FIG. 3B is a side view of the embodiment of the inventive carrier from FIG. 3A with a tire chock in a deployed configuration.

FIG. 3C is a partial perspective view of another embodiment of the inventive carrier with a tire chock in a stowed configuration.

FIG. 3D is a partial perspective view of another embodiment of the inventive carrier with a tire chock in a deployed configuration.

FIG. 4A is a detail perspective view of a tire chock of an embodiment of the inventive carrier in a stowed configuration.

FIG. 4B is a detail side view of the tire chock of the embodiment of the inventive carrier from FIG. 4A in a stowed configuration.

FIG. 4C is a detail perspective view of the tire chock of an embodiment of the inventive carrier from FIG. 4A in a deployed configuration.

FIG. 4D is a detail side view of a tire chock of an embodiment of the inventive carrier in a deployed configuration.

FIG. 5A is a partial perspective view of another embodiment of the inventive carrier with a tire chock in a stowed configuration.

FIG. 5B is a partial perspective view of the inventive bicycle carrier of FIG. 5A with a tire chock in a deployed configuration.

FIG. 6A is a detail perspective view of the tire chock of FIG. 5A in a stowed configuration of the inventive bicycle carrier.

FIG. 6B is a detail perspective view of the tire chock of FIG. 5A in a deployed configuration of the inventive bicycle carrier.

FIG. 6C is a cross-sectional side view of the tire chock of FIG. 5A in a deployed configuration of the inventive bicycle carrier.

FIG. 6D is a partial perspective view of the tire chock of the embodiment of FIGS. 5B and 6B with some components removed for clarity.

FIG. 6E is a cross-sectional view of the tire chock of the embodiment of FIGS. 5B and 6B.

FIG. 6F is a top view of a portion of an embodiment of the bicycle carrier.

FIG. 7A is a perspective view of a portion of an additional embodiment of the inventive bicycle carrier.

FIG. 7B is a perspective view of a portion of an additional embodiment of the inventive bicycle carrier.

FIG. 8A is a side cross-sectional view of the tire chock of an additional embodiment of the inventive bicycle carrier in a deployed configuration.

FIG. 8B is a side cross-sectional view of the tire chock of an additional embodiment of the inventive bicycle carrier in a partially closed or stowed configuration.

FIG. 8C is a side cross-sectional view of the tire chock of an additional embodiment of the inventive bicycle carrier in a closed or stowed configuration.

### DETAILED DESCRIPTION

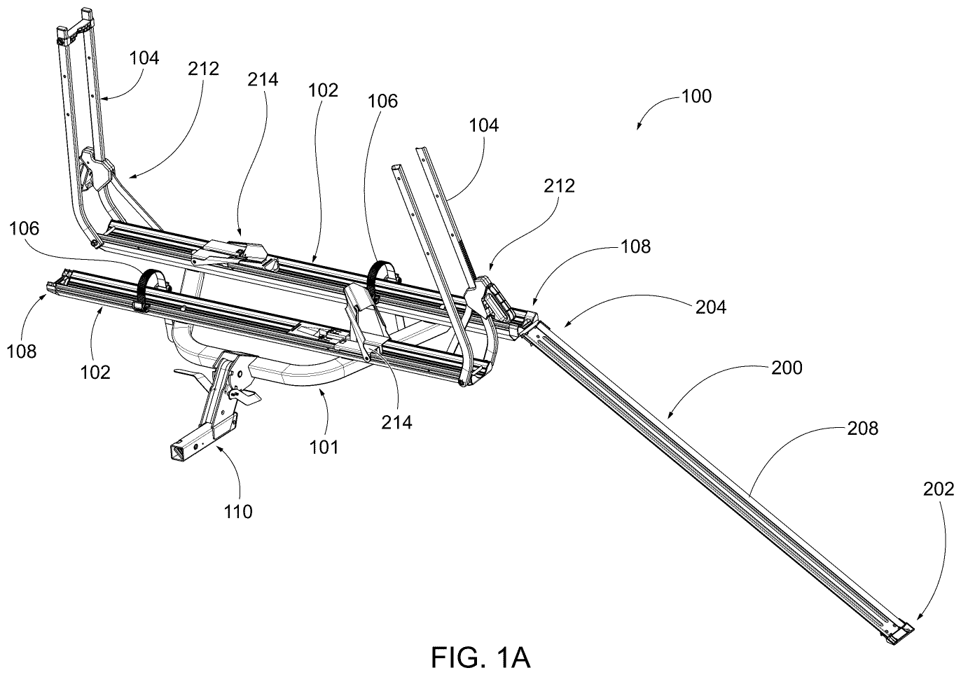

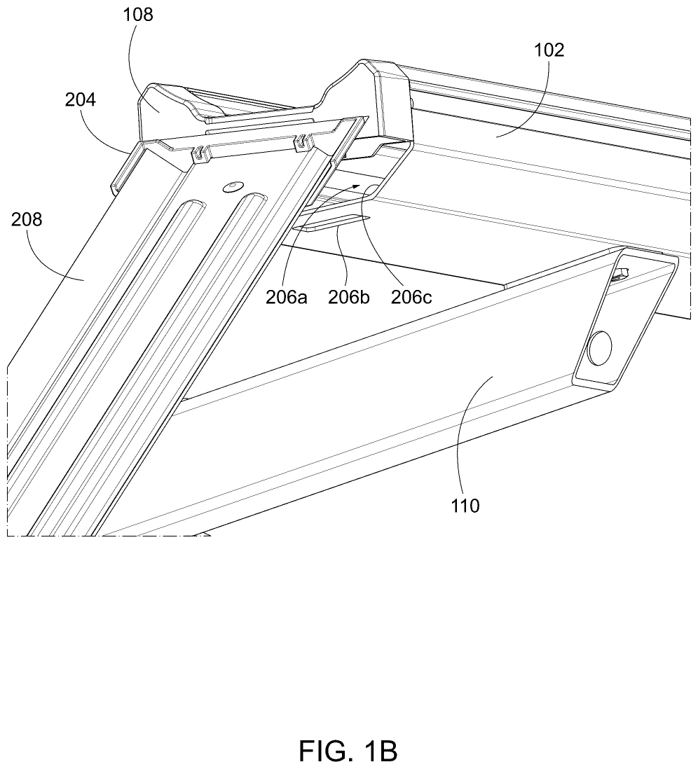

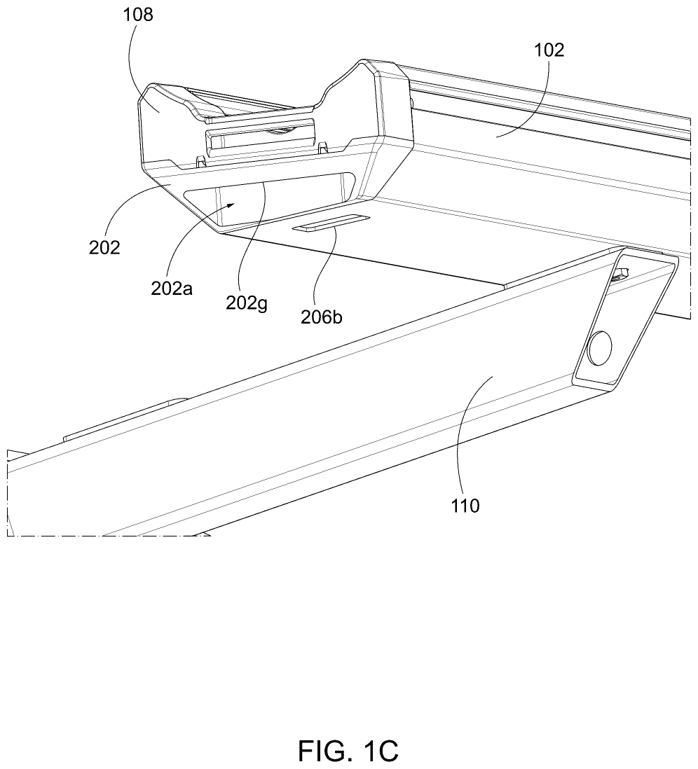

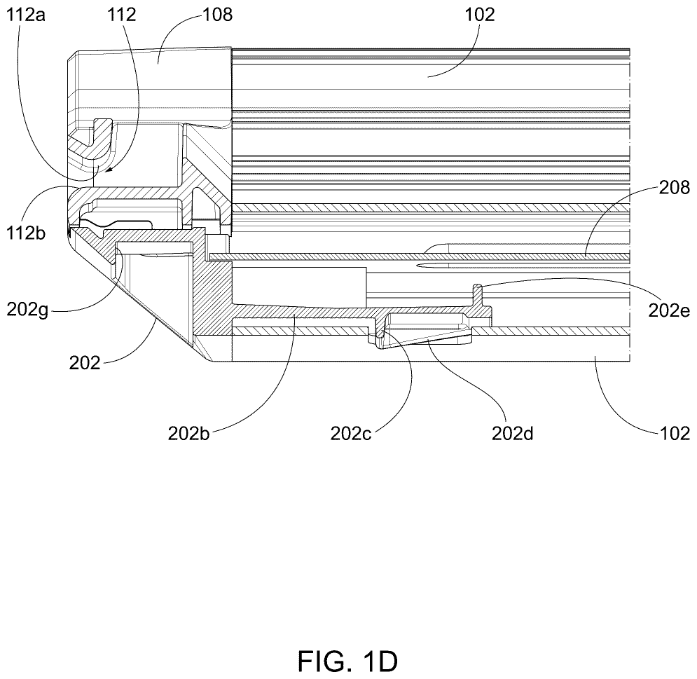

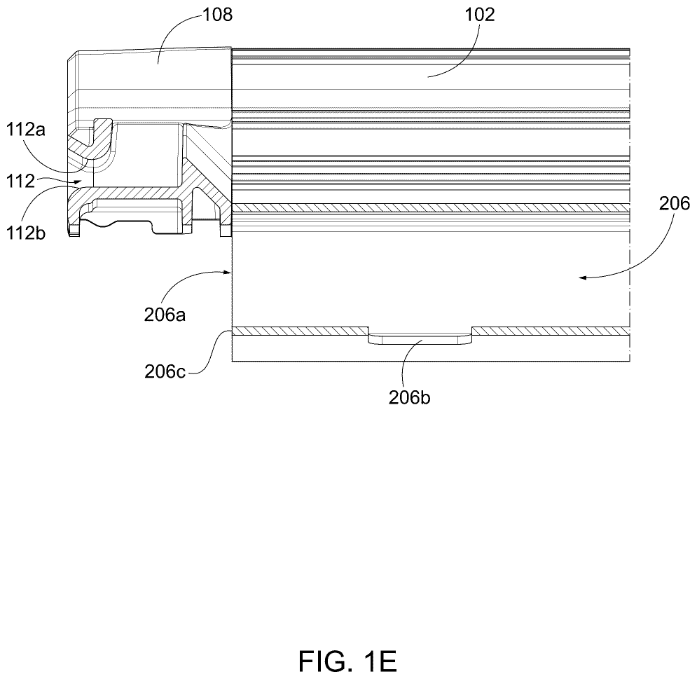

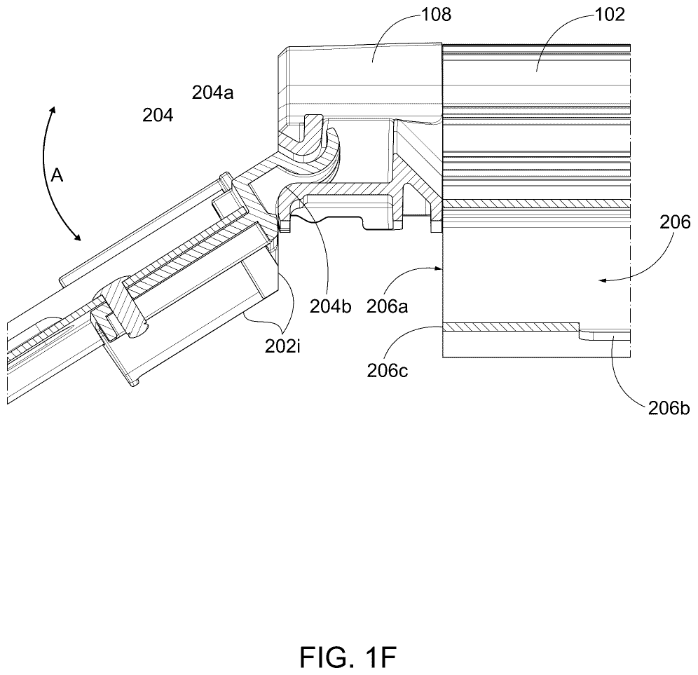

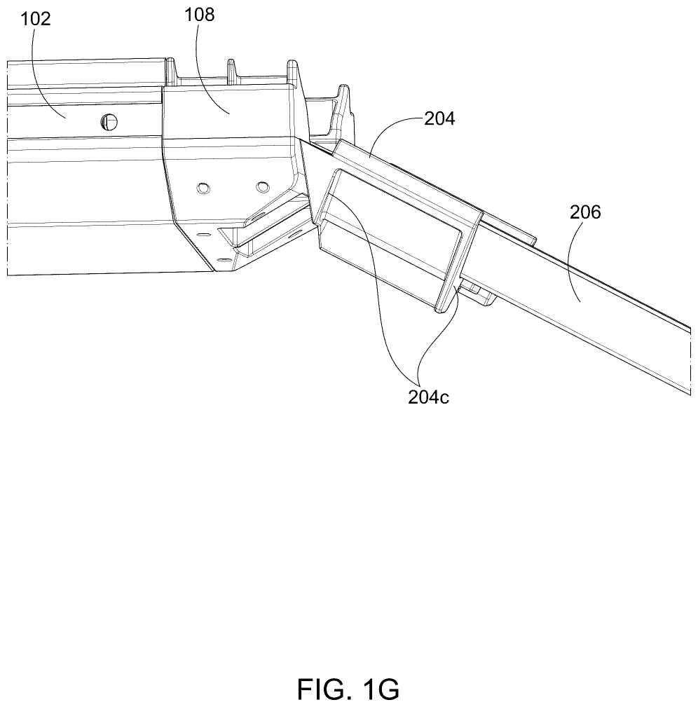

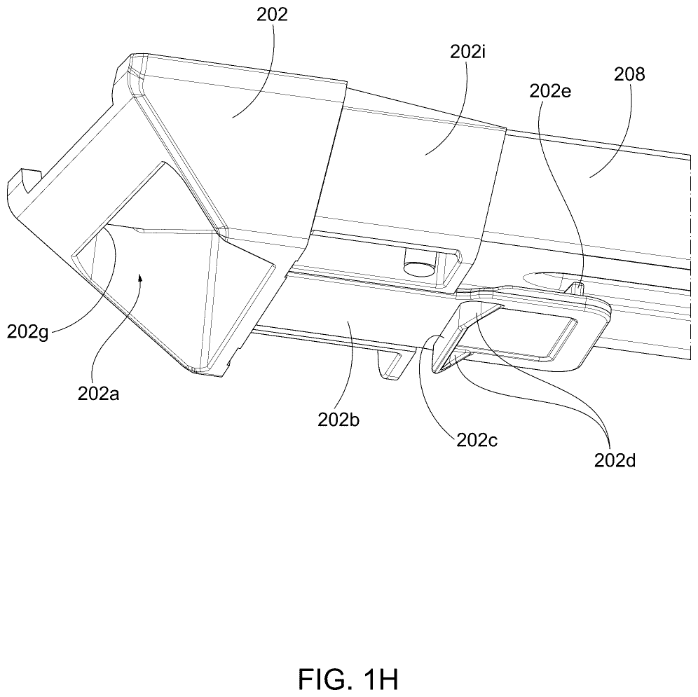

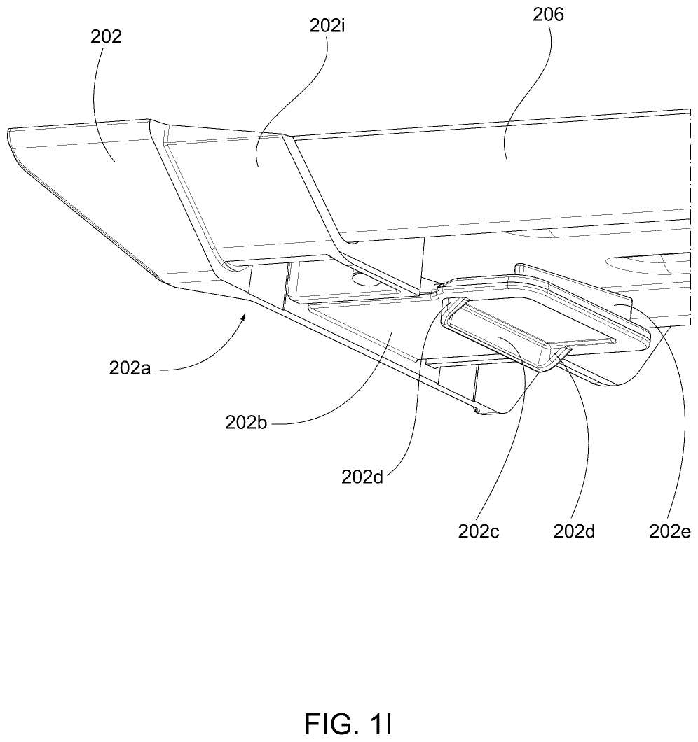

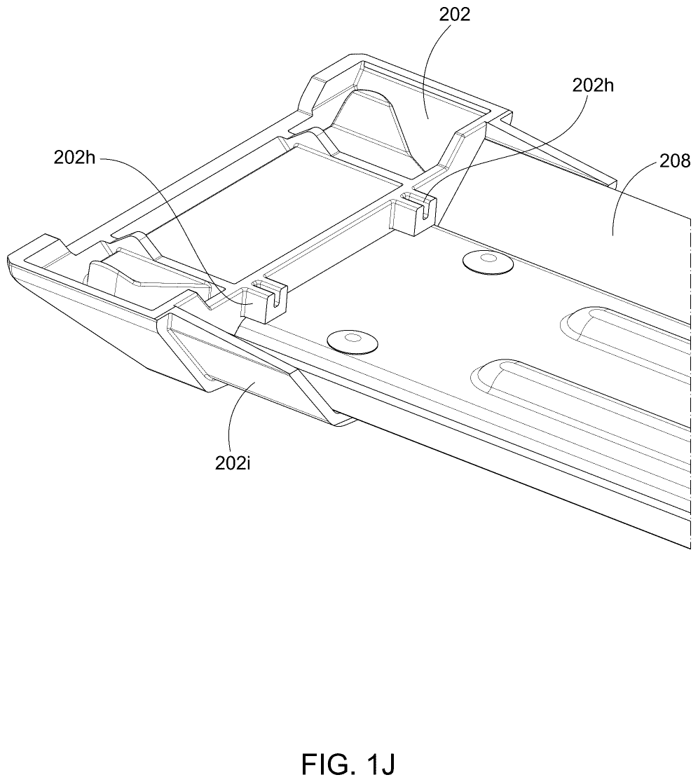

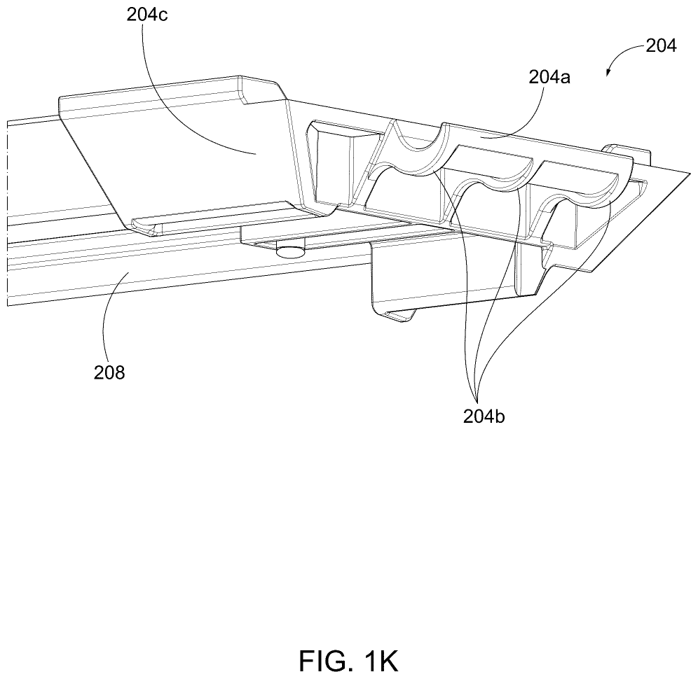

Referring to FIG. 1A, a bicycle carrier 100 is shown with a ramp accessory 200 in a deployed configuration. The bicycle carrier 100 may be provided with a variety of mechanisms for attaching it to a vehicle at a vehicle attachment point 110, such as the depicted drawbar for a receiver hitch, or in other embodiments a clamp for a ball hitch or another attachment method. The method of attachment to a vehicle is not limiting of the scope of the invention. In this deployed configuration of the ramp, a user may roll a bicycle up the ramp 200 onto the tire platform 102 of the bicycle carrier 100. The user may then secure the bicycle on the bicycle carrier 100 in whatever manner is provided for that purpose. In the depicted embodiment the bicycle may be secured on the bicycle carrier 100 by a wheel securement arm 104 and wheel strap 106, however the method of securement is not limiting of this aspect of the inventive bicycle carrier 100 and ramp accessory 200. Later figures in this disclosure depict a different method of securing a bicycle on the carrier 100.

Referring to FIG. 1B, a closeup view is depicted of the connection between the ramp accessory 200 and the bicycle carrier 100 in the deployed configuration. The second end 204 of the ramp 200 is shown in connection with the first end 108 of tire platform 102 at a site that is on the end of the platform 102 and that allows the ramp's upper surface to approximately coincide with the top surface of the platform 102 to allow for easier rolling of a bicycle onto the platform 102 from ramp 200. In the depicted embodiment, beneath the point of attachment is the aperture 206a into a ramp storage cavity 206. In this embodiment the cavity 206 is in the outer tire platform 102, meaning the platform 102 that is farther away from the point of vehicle attachment point 110. In other embodiments the cavity 206 may be in either the inner or outer tire platform or there may only be one platform.

Referring to FIG. 1C, a detail view is shown of an embodiment of the ramp 200 inserted into the cavity 206 in the tire platform 102. The first end 202 of the ramp accessory 200 covers the aperture 206a. In this embodiment the first end 202 is provided with a handle 202a formed as part of an end cap on the first end 202 of the ramp 200. This figure depicts a stowed configuration in which the bicycle carrier may be used to carry a bicycle behind a moving vehicle, or to store the ramp 200 when the bicycle carrier is not in use. The ramp 200 is easily removed from and inserted back into the cavity 206 so that it doesn't take up valuable space in a car or other vehicle and doesn't interfere with the external look of the rack product.

Referring to FIG. 1D, a cross-sectional view is depicted of the first end 108 of the tire platform 102 with the ramp 200 in the stowed configuration. In the depicted embodiment a handle feature 202a is provided to allow a user to pull the ramp 200 out of the storage cavity 206 when desired. In this embodiment the handle 202a is formed as part of an end cap or member for the ramp 200. In this embodiment the handle 202a comprises a lip or flange 202g with a cavity behind it sufficient to be engaged by a user's fingers or fingertips.

The ramp body 208 extends into the ramp storage cavity 206. In the depicted embodiment an optional latch mechanism is provided to secure the ramp accessory 200 in the stowed position in the storage cavity 206. The depicted embodiment of the latch mechanism comprises a tab 202b extending from the first end 202 of the ramp 200 into the storage cavity 206. This embodiment of the tab 202b has a flange or protrusion 202c disposed at a point along its length. The position and shape of the protrusion 202c is selected to engage a feature 206b on the storage cavity 206. In the depicted embodiment the feature 206b comprises an aperture through the exterior face of the storage cavity 206 with an edge 206c for engaging the protrusion 202c to hold the ramp 200 in the storage cavity 206. In the depicted embodiment the protrusion 202c does this by directly contacting the edge 206c of the aperture 206b thus preventing the end cap of the ramp 200 from moving outward from the storage cavity 206.

In the depicted embodiment, the tab 202b, or some portion of it, is formed from a flexible material or the tab 202b is attached to the end cap of the ramp accessory 200 by a flexible joint. The ability to flex the tab 202b with respect to the position shown in FIG. 1D allows a user to press on the tab 202b through aperture 206b and disengage the protrusion 202c from feature 206b. In the depicted embodiment this results in the protrusion 202c moving inwardly into the storage cavity 206 until it no longer engages edge 206c and thus no longer prevents the ramp accessory 200 from sliding outwardly from the storage cavity 206.

In the depicted embodiment, the protrusion 202c is provided with angled side edges 202d to guide the protrusion 202c and the tab 202d into the storage cavity 206 as a user reinserts the ramp accessory 200 into the ramp storage cavity 206. In this embodiment the angled side edges 202d slide on the edge 206c of aperture 206a, causing the tab 202b to flex and protrusion 202c to slide along the inner surface of the cavity 206 until reaching feature 206b. In a preferred embodiment tab 202b is resilient or shaped to automatically engage the feature/aperture 206b when they are adjacent to one another. In some embodiments a stop feature 202e may be provided on tab 202b to prevent over-flexion by contacting ramp 200 when protrusion 202c has disengaged from edge or feature 206c.

FIG. 1E depicts the same cross-sectional view of an embodiment of the inventive bicycle carrier as shown in FIG. 1D but with the ramp 200 removed from the internal storage cavity 206. The ramp 200 is not depicted in FIG. 1E. The ramp attachment point 112 in the depicted embodiment comprises a cavity with upper and lower surfaces 112a and 112b respectively, designed to engage a feature on the second end 204 of the ramp 200 as shown in FIG. 1F. In the embodiment shown in FIG. 1F the ramp 200 is shown removably attached to the first end 108 of the tire platform 102 at the ramp attachment point 112 in its operational configuration. In this embodiment the ramp 200 may be pivoted up and down as shown by arrow A to engage and disengage the ramp attachment feature 204a to and from the ramp attachment point 112. In the depicted embodiment ramp attachment feature 204a comprises a hook-shaped member to pivot into the cavity 112. The hook-shaped member 204a of this embodiment engages the upper surface 112a of the attachment point/cavity 112. In this case the second end 204 of the ramp also has a lower surface 204b for engaging the lower surface 112b of the ramp attachment point 112. In the configuration shown in FIG. 1F, the first end 202 of the ramp 200 is not shown but would be supported on the ground or other surface where a bicycle can be rolled onto the ramp body 208 and up onto the tire platform 102. FIG. 1G depicts another view of the embodiment shown in FIG. 1F but not in cross-sectional view.

Referring now to FIGS. 1H and 1I, detailed perspective views of the first end 202 of ramp 200 are depicted with the ramp 200 removed from the storage cavity 206. In these views the handle feature 202a, latch tab member 202b, latch flange/protrusion 202c, and flange side edges 202d of this embodiment of the bicycle carrier are clearly visible. Latch stop protrusion 202e is visible between tab member 202b and the lower surface of the ramp body 208. The first end member 202 may be attached to the ramp body 208 by rivets (as depicted), screws, bolts, or other similar types of fasteners, or the two parts may be formed unitarily from a single member.

FIG. 1J depicts a top perspective view of the first end of an embodiment of the ramp accessory 200. The end member 202 may be provided with the depicted receptacles or notches 202h for receiving features of the end of storage cavity 206. These may help position the ramp 200 in the cavity 206 or hold it in place in the cavity 206. In some embodiments these features are ribs or cross-members of an extrusion forming platform 102.

FIG. 1K depicts a perspective view of the second end 204 of an embodiment of the ramp accessory 200. The width of the ramp attachment member 204a in this embodiment is clearly visible. The width of the member in varying embodiments provides additional stability to the connection to prevent wobbling of the ramp 200 when in use. In the depicted embodiment the ramp attachment member 204a has a cross-section that is approximately hook-shaped. In this embodiment the upper and lower surfaces of the attachment/hook member 204a are curved to engage and be retained by the ramp attachment cavity 112 when the ramp is in the deployed position. However, when the ramp is pivoted to the up position the ramp attachment member 204a is disengaged from the ramp attachment cavity 112 and the ramp 200 may be detached from tire platform 102. In varying embodiments, the ramp attachment member may be a different cross-sectional shape, or varying widths, or there may be more than one ramp attachment member completely or partially separated from one another. In the depicted embodiment the lower surface is ribbed so that the contact area between the member 204a and the lower surface 112b is only along the three ribs 204b.

The first and second end members 202 and 204 respectively of the ramp accessory 200 may be shaped to fit snugly into the internal shape of the cavity 206 to prevent the ramp 200 from moving around in the cavity 206 when it is stored therein. In the depicted embodiments the shaped areas of end members include surfaces 202i and 204c.

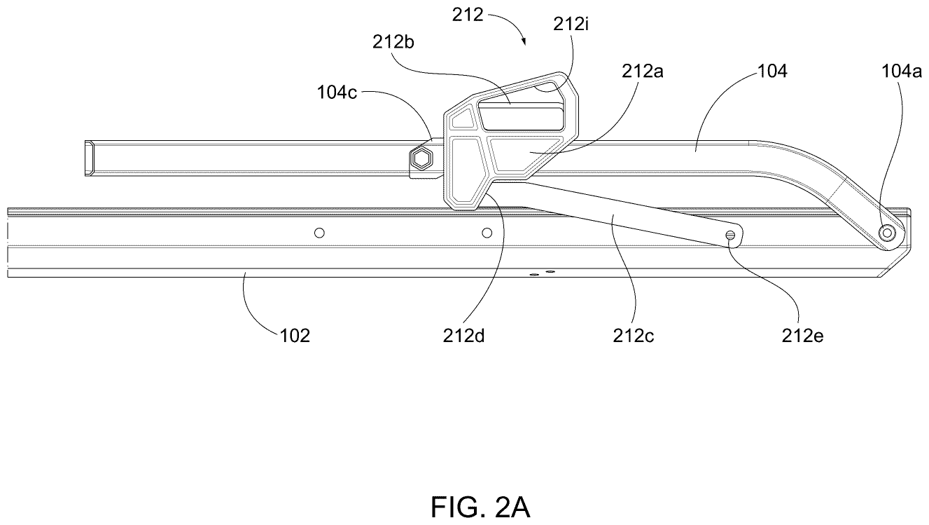

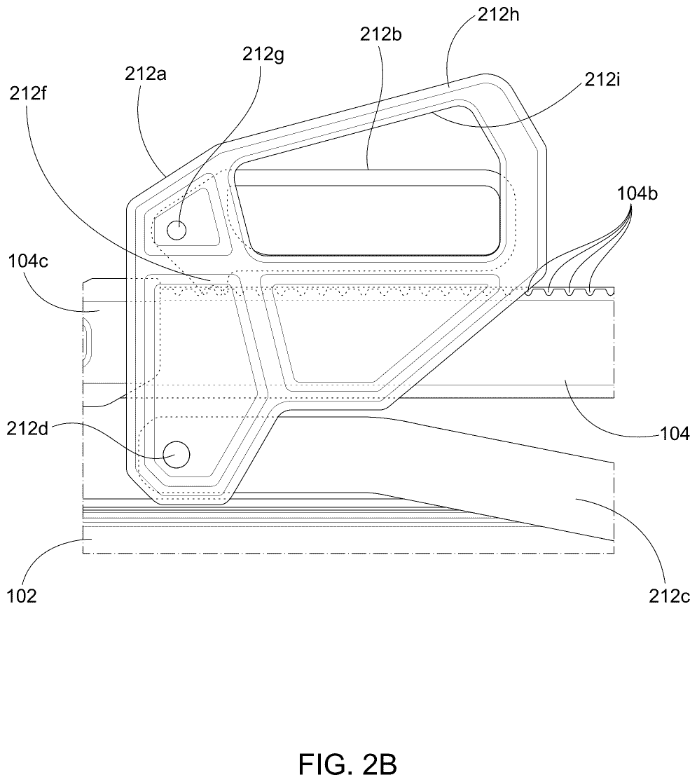

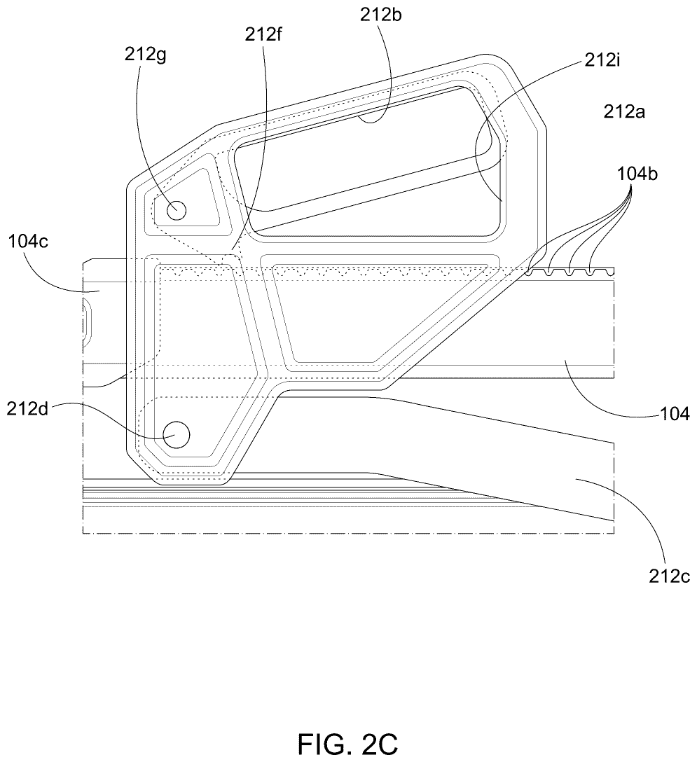

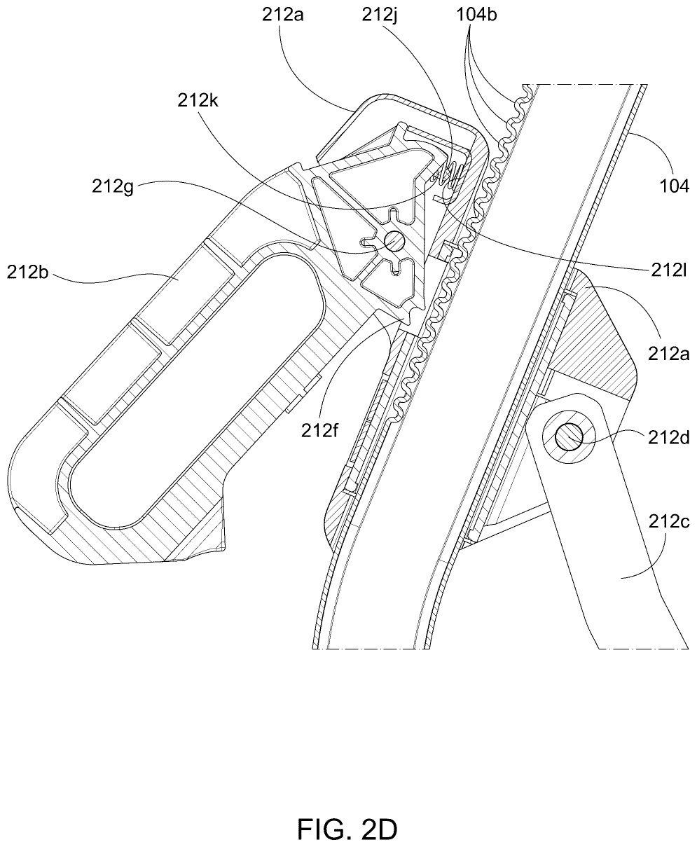

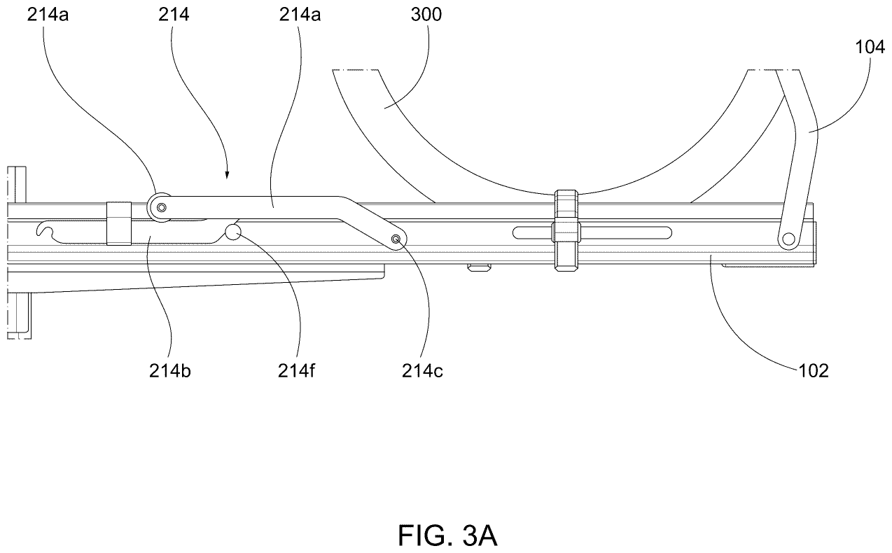

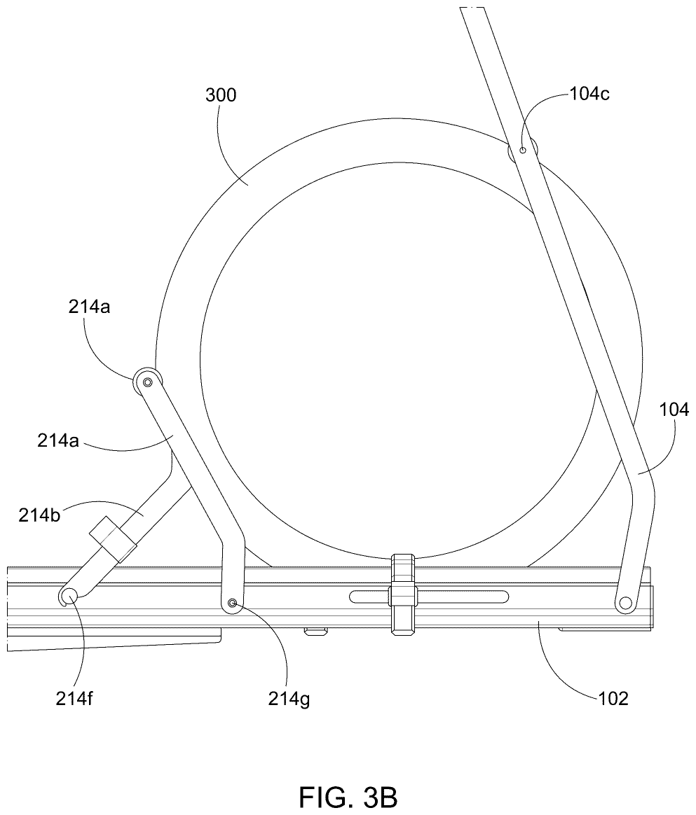

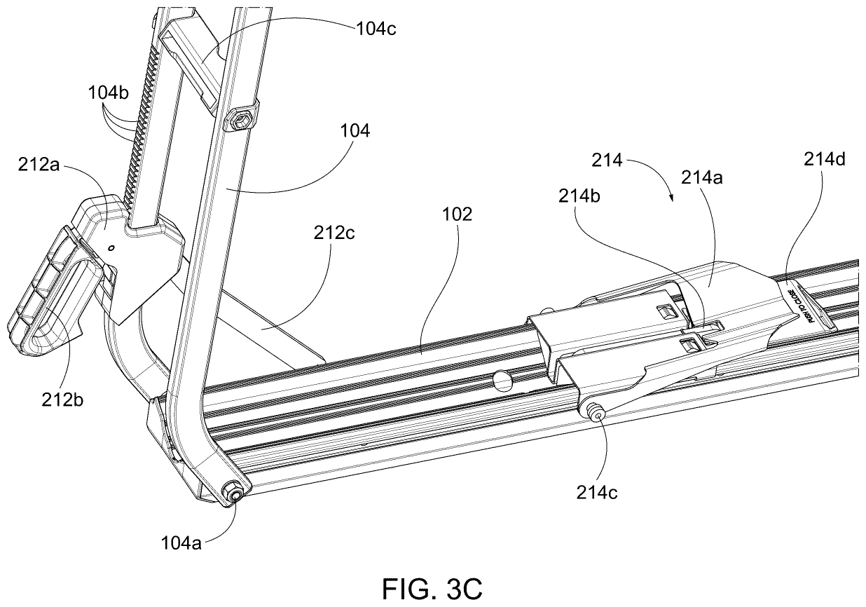

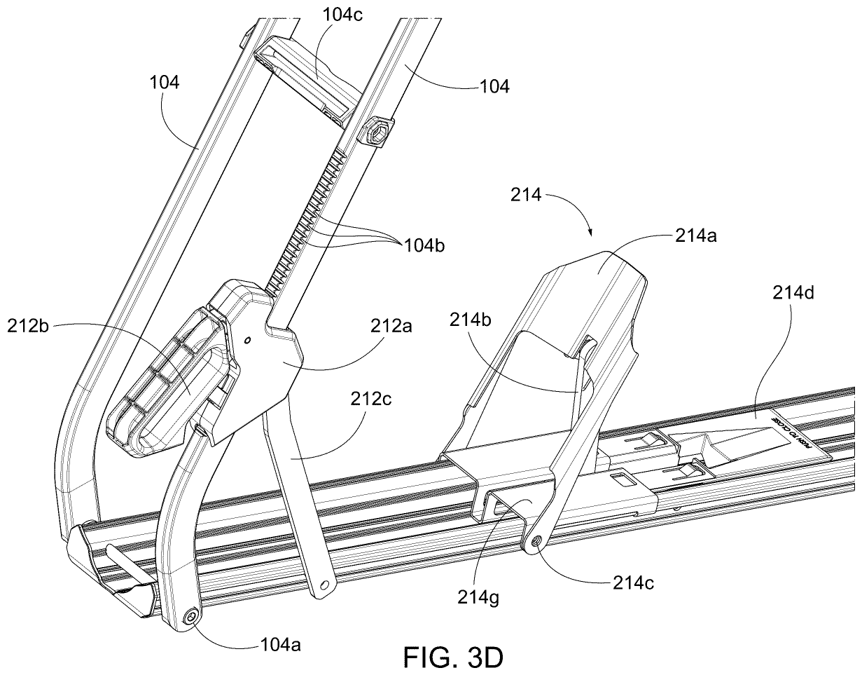

In some embodiments the inventive bicycle carrier 100 includes a tire/wheel securement arm 104. Some embodiments of the inventive bicycle carrier utilize a wheel securement arm to contact a tire of a bicycle to secure the bicycle on the tire platform 102. In some embodiments one wheel securement arm is provided at either end of the platform 102. In other embodiments one wheel securement arm 212 may be combined with a tire chock as described in relation to later figures. In the storage configuration (also referred to as the closed position) shown in FIG. 2A, the wheel securement arm 104 is pivoted close to, adjacent to, or in proximity to the tire platform 102. The wheel securement arm 104 may be pivoted to an open or loading configuration/position to load a bike (like those shown in FIG. 1A), then optionally moved or adjusted to a secured/loaded position against the tire or frame of a bicycle, or both (like that shown in FIG. 3B. Embodiments of the bicycle carrier 100 have inventive methods for manipulating and moving the wheel securement arm 104, and inventive mechanisms for operating and securing the wheel securement arm 104. FIGS. 2A through 2D depict an embodiment of the inventive support arm assembly 212 for operating and securing the wheel securement arm 104.

Some embodiments of the inventive bicycle carrier 100 have a support arm assembly 212 for a user to manipulate the wheel securement arm 104 to hold and support the arm 104 in multiple positions from a storage configuration to a loading configuration to a secured configuration, and optionally any point in between these three positions. In some of these embodiments the wheel securement arm 104 may be moved between positions with the use of only one hand.

In varying embodiments of the bicycle carrier, the wheel securement arm 104 is pivotally attached to the tire platform 102 at a first point 104a to allow it to pivot from the closed position of FIG. 2A to open positions for placing a bicycle on the tire platform 102, and secured positions where the arm secures the bicycle tire on the tire platform 102. In embodiments of the inventive bicycle carrier 100, the rotational position of the wheel securement arm 102 with respect to the tire platform 102 is maintained by a support arm assembly 212.

The inventive support arm assembly, in varying embodiments, comprises a sliding member/latch body 212a that slides along all or some portion of the length of the wheel securement arm 104. The sliding member 212a may fully or partially wrap around the arm 104 or be slidably engaged by features on the arm 104 such as lengthwise t-channels or grooves. In varying embodiments, a support arm member 212c is pivotally attached at its first end 212d to the sliding member/latch body 212a. In these embodiments the support arm member may also be movably attached to the tire platform 104 at a second end 212e. As the sliding member/latch body 212a slides along the length of the wheel securement arm 104, the geometry of the support arm member 212a and its connections at 212d and 212e causes the wheel securement arm 104 to pivot around its attachment to tire platform at point 104a. This rotation of the wheel securement arm 104 allows the user to rotate it from one position to another, such as from the closed/stowed configuration to the open/loading configuration, or to the secured/loaded configuration with a bike on the bicycle carrier 100.

In some embodiments the support arm assembly incorporates a latch mechanism 212f that allows a user to fix the sliding member 212a in place on the wheel securement arm 104. In the embodiment depicted in FIGS. 2B and 2C this is visible through the transparent representation of sliding member 212a. In these embodiments the support arm assembly is provided with a latch actuator 212b that allows a user to disengage the latch mechanism 212f in the support arm assembly 212. The latch mechanism may comprise a clamp that clamps onto the wheel securement arm 104, a ratchet pawl that engages a linear ratchet rack on the arm 104, a pinion or one or more fixed teeth that engage a linear rack on the wheel securement arm 104, or a pin that inserts into a hole or cavity in the wheel securement arm 104. Other latch/clamp mechanisms may be used in the support arm assembly 212 as will be obvious to one of skill in this art. In the depicted embodiment the latch mechanism is a toothed pawl 212f that engages a linear rack or series of indentations or protrusions 104b formed on or attached to the wheel securement arm 104. In the depicted embodiment the latch mechanism 212f is pivotally attached to sliding member 212a at pivot axis 212g, but in other embodiments the latch mechanism 212f or actuator 212b may move linearly with respect to sliding member 212a.

In some embodiments with a ratchet and pawl type latch mechanism 212f a user may apply force to any part of the wheel securement arm 104 that would pivot it in one direction A shown in the figures, toward the closed/stowed or loaded/secured configurations, and the latch mechanism 212f will ratchet to allow the sliding member 212a to move along the arm 104 without actuator 212b being manipulated by the user in any way. In other embodiments a user may be required to hold the actuator 212b in the disengaged position while pivoting arm 104a. In ratchet type mechanisms the ratchet prevents the sliding member 212a from moving in the other direction along wheel securement arm 104 thus holding it in the closed/stowed or loaded position in which the user places it until such time as the user disengages the latch mechanism 212f using actuator 212b.

In the depicted embodiment, when a user applies the correct force to actuator 212b it will pivot latch mechanism 212f around pivot axis 212g. This pivotal motion is configured to engage or disengage the teeth/pawl 212f from the indentations 104b forming the linear rack on the wheel securement arm 104 depending on the direction of motion of the actuator 212b. In other embodiments the movement of the actuator 212b or the latch mechanism 212f may be linear or substantially linear.

In the depicted embodiment the actuator/trigger 212b and latch mechanism 212f are partially contained inside a housing portion of the sliding member 212a. In these embodiments the sliding member may have an aperture 202i to allow a user to insert all or a portion of their hands into the housing to access the actuator 212b. In the depicted embodiment the sliding member has a handle 212h that may be squeezed with the actuator 212b by the user when they want to disengage the latch mechanism. In such embodiments the user may be able to grip the actuator 212b to disengage the latch mechanism 212f, and while squeezing the handle 212h together with the actuator 212b the user may slide the sliding member 212a along the length of wheel securement arm 104 thus causing arm 104 to pivot with respect to the tire platform 102.

In some embodiments, the actuator/trigger 212b or latch mechanism 212f may be provided with a biasing mechanism 212j such as a torsion spring around pivot axis 212g with extensions that contact protrusions on the sliding member 212a and the actuator 212b to exert a force on the actuator 212b and push it back toward the engaged position. In other embodiments the biasing mechanism may be a compression or extension spring between the actuator 212f and the sliding member 212a, or other biasing mechanisms as will be apparent to one of skill in the art.

FIG. 2A depicts the wheel securement arm 104 and the support arm assembly in a closed/stowed configuration. FIGS. 2B and 2C depict detailed views of the portion of the support arm assembly 212 where the sliding member 212a is located, with the sliding member 212a shown transparently similar to the effect of a cross-sectional view.

FIG. 2D depicts a cross-sectional view of the support arm assembly 212 of an additional embodiment of the bicycle carrier. In this embodiment the sliding member 212a does not include a handle 212h. It does include a compression spring 202j between a bearing surface 202k on the actuator 202b and a bearing surface 202l on the sliding member. As the actuator/trigger 212b is pivoted to the disengaged position the spring 202j is compressed and urges the actuator 212b back to the engaged position as soon as a user removes a disengaging force. In this embodiment trigger 212a serves as a handle for the latch mechanism to slide it on the wheel securement arm. As can be seen in FIG. 2D, in some embodiments the ratchet rack indentations 104b are formed in the material of the wheel securement arm itself.

In some embodiments of the inventive bicycle carrier a back-side tire chock is provided on the tire platform 102. As shown in FIGS. 3A and 3B, the back-side tire chock assembly 214 folds down adjacent to the tire platform 102 in a stowed configuration. In this position a user may roll a bicycle tire over the back-side chock 214 as the bicycle is loaded on the tire platform 102. Once the bicycle tire is in the desired position such as shown in FIG. 3A, the user may raise the back-side tire chock 214 to provide an opposing bearing surface to the wheel securement arm 102, and then pivot the wheel securement arm 102 into contact with the tire of the bicycle.

In one method of using the inventive bicycle carrier, a bicycle is rolled up a ramp 200 onto tire platform 102 until a first tire of the bicycle has rolled over the back-side tire chock assembly (when it is in the stowed configuration). Next the user raises the back-side tire chock assembly 214 to the deployed configuration, rolls the bicycle tire into contact with the back-side tire chock, and then pivots wheel securement arm 104 toward the tire of the bicycle until the tire is firmly held or squeezed between the back-side tire chock assembly 214 and the wheel securement arm 104.

In the embodiment of the back-side tire chock assembly 214 depicted in FIGS. 3A and 3B, the assembly comprises a tire chock member 214a and a support member 214b. In this embodiment the tire chock member 214a comprises two side arms and a cross piece that are pivotally attached to either side of the tire platform at pivot axis 214c. On each side a support arm 214b is pivotally attached to one of the side arms of the tire chock 214a at a first end and provided with a pin receptacle at another end. The pin receptacle may receive a bearing pin 214f when the tire chock is raised up to the deployed configuration as shown in FIG. 3B. In the configuration depicted in FIG. 3B the bicycle tire 300 is secured between tire chock 214a and tire chock 104c.

FIG. 3C depicts another embodiment of a bicycle carrier 100 with a back-side tire chock assembly 214 with a support arm assembly 212. The support arm assembly 212 is partially open in this depiction, while the tire chock assembly 214 is in the stowed configuration. In this combination of configurations, a bicycle could be rolled or lifted onto the rack and one wheel rolled across the back-side tire chock 214 into contact with securement arm 104. Then the back-side tire chock assembly 214 may be deployed as shown in FIG. 3D and the support arm assembly 212 disengaged as shown therein to pivot the securement arm 104 against a bicycle tire disposed between the tire chocks 104c and 214a.

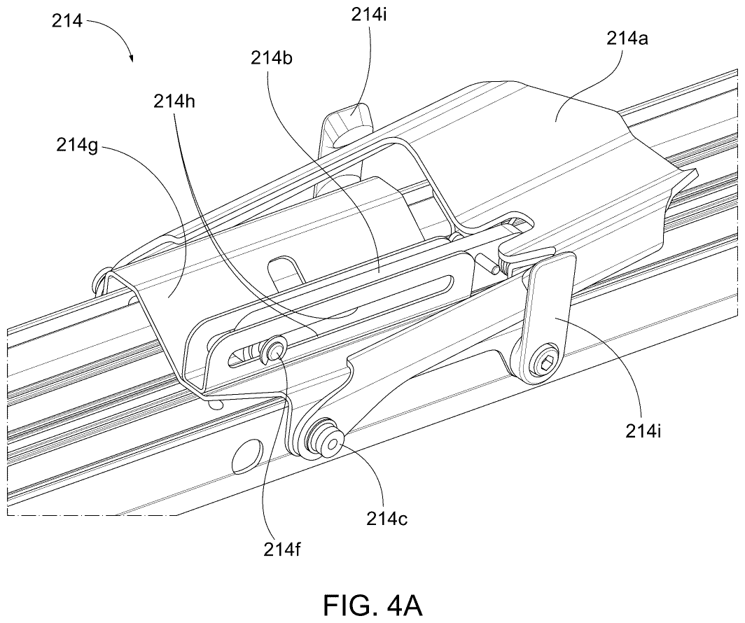

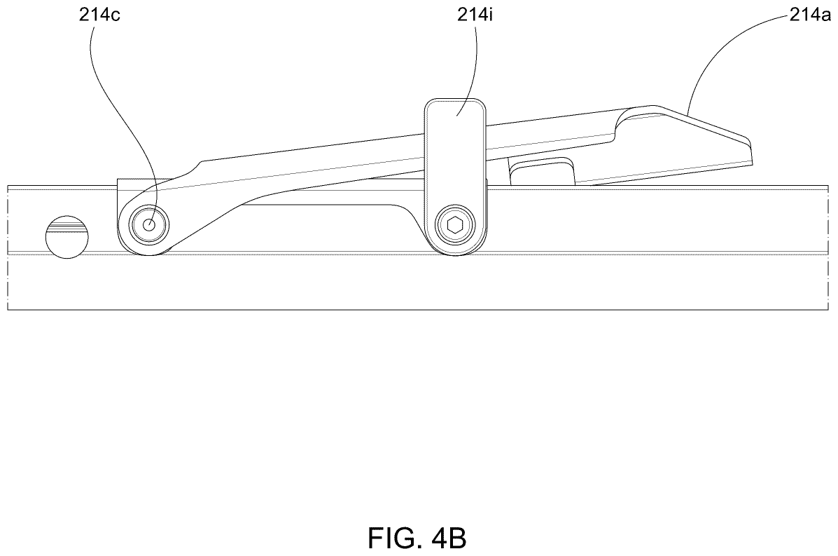

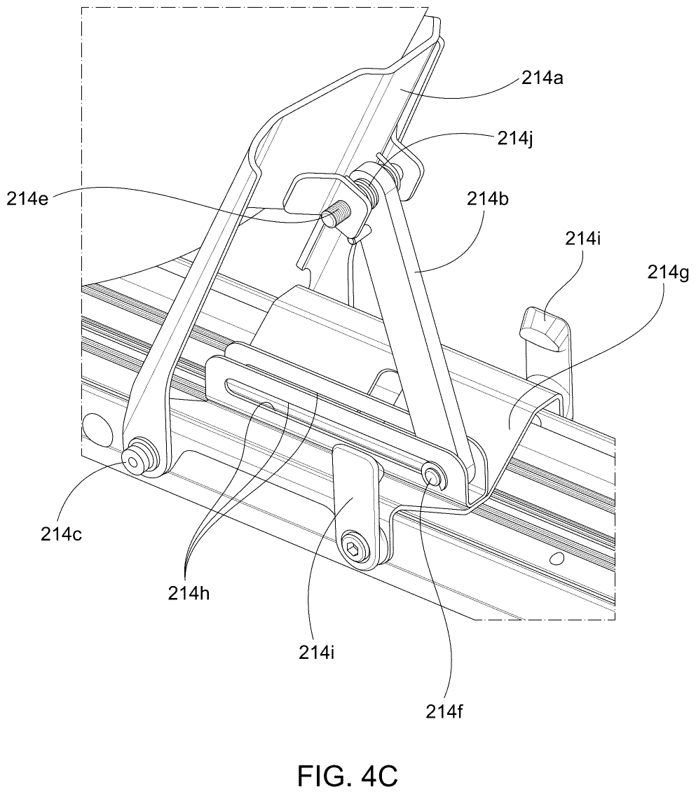

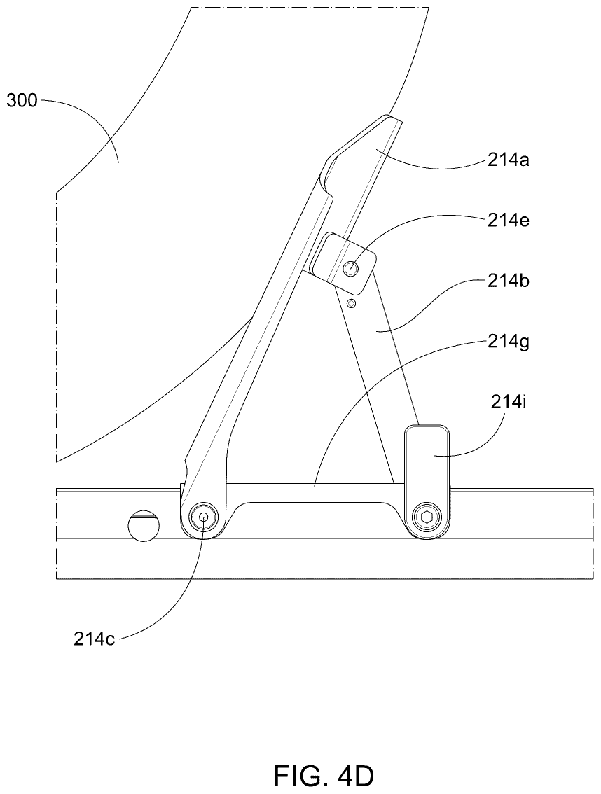

FIGS. 4A and 4B depict an additional embodiment of the back-side tire chock 214 in a stowed position. In this embodiment the tire chock 214a has two side arms pivotally attached to either side of the tire platform 102 at 214c. In this embodiment optional retention clips or tabs 214i are attached to the tire platform 102. This embodiment of retention clips 214i are provided with flexible arms having protrusions to engage the tire chock 214a and hold it in the stowed configuration. These retention clips may be overcome by sufficient force to bend the out of the way of upward pivotal motion of tire chock 214a.

In the embodiment in FIG. 4A there is a single support arm 214b disposed in the center of the tire chock 214a and tire platform 104c. One end of the support arm 214b is pivotally attached at 214e to a bracket on tire chock 214. The other end is provided with a bearing pin or pins 214f that slide in a slot or groove 214h in base member or carriage 214g. A retainer clip may be used to hold the pins 214f in the slot 214h.

When a user raises the tire chock 214a to the deployed position shown in FIGS. 4c and 4D, the support arm 214b is moved pivotally as the pins 214f slide in slot 214h. In some embodiments a spring or biasing mechanism 214j is provided to urge the support arm 214b into the position shown in FIGS. 4C and 4D. As the chock 214a is raised, the arm 214b pivots and pin 214f slides in groove 214h, the arm 214b eventually goes past a “vertical” orientation so that it is “over-center” or forms a triangle when seen from the side in FIG. 4D. As pin 214f contacts the end of the slot 214h the triangle becomes a rigid support for pressure exerted by the tire 300. This allows a user to easily open and deploy the back-side chock 214 by pulling up on tire chock member 214a until the force of spring 214j snaps support arm 214b into the triangular deployed position.

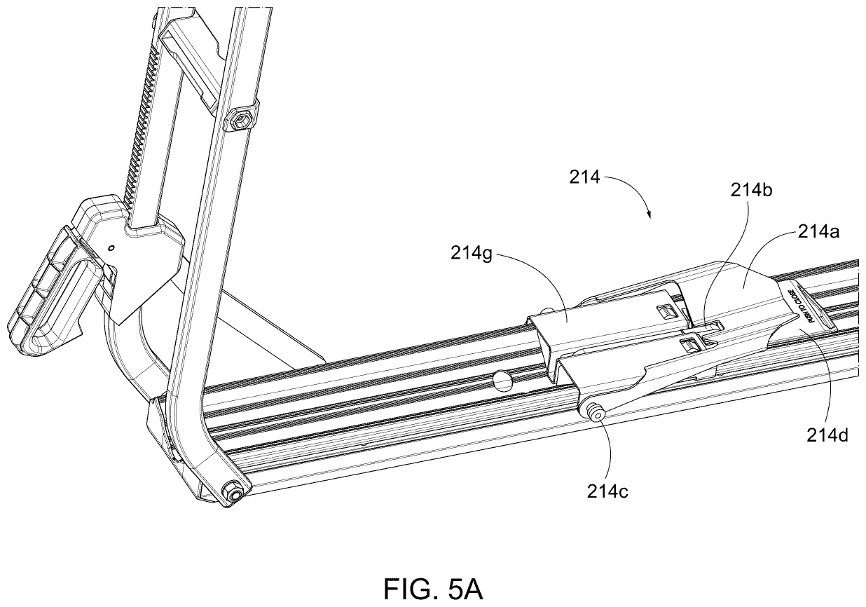

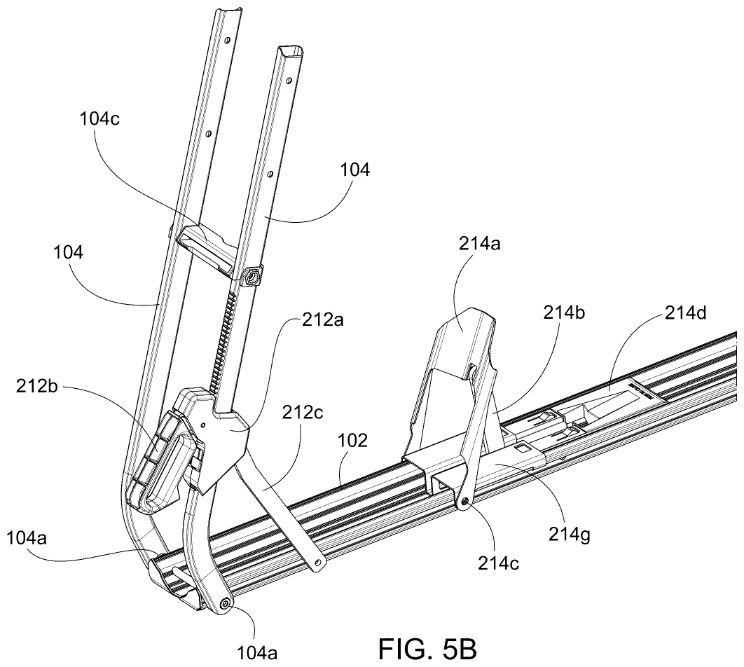

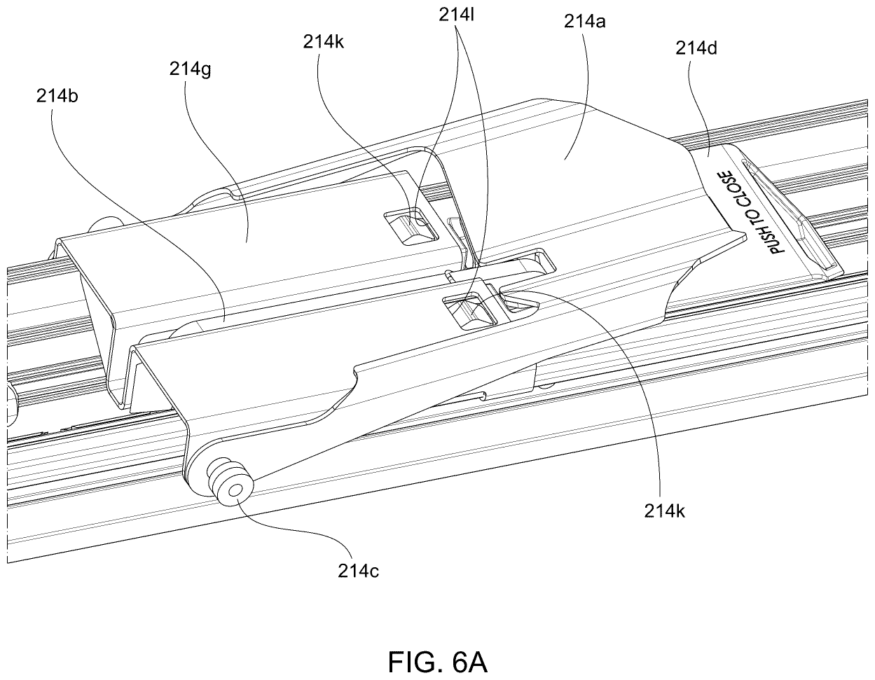

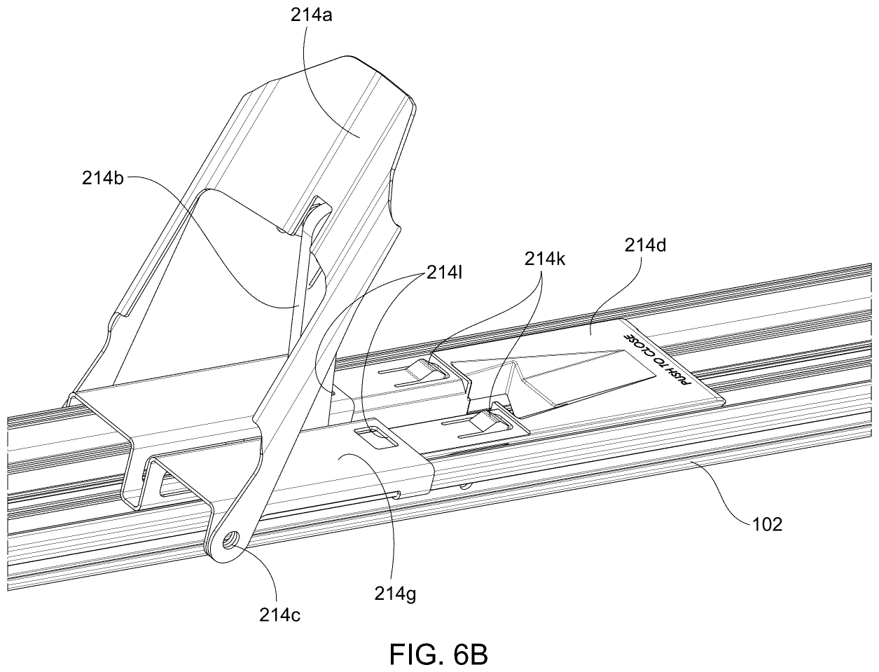

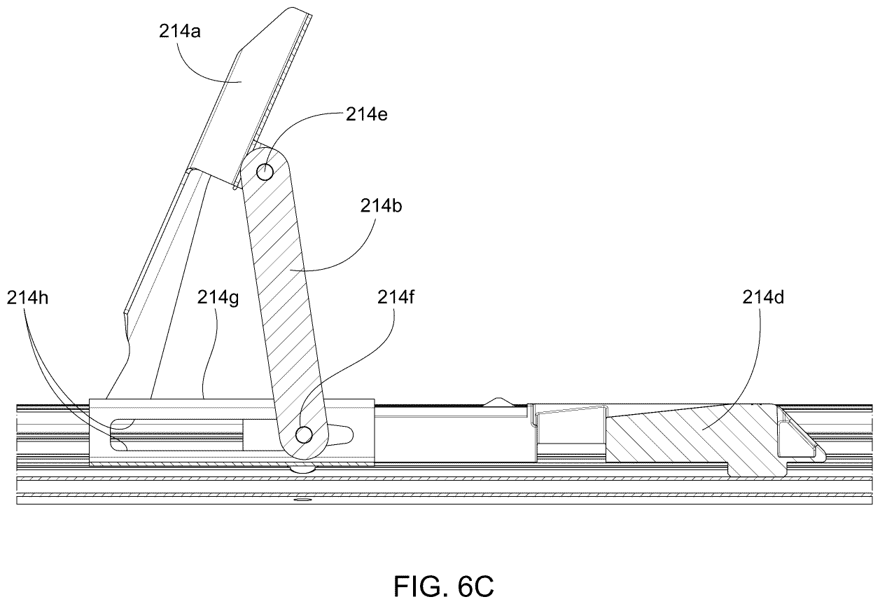

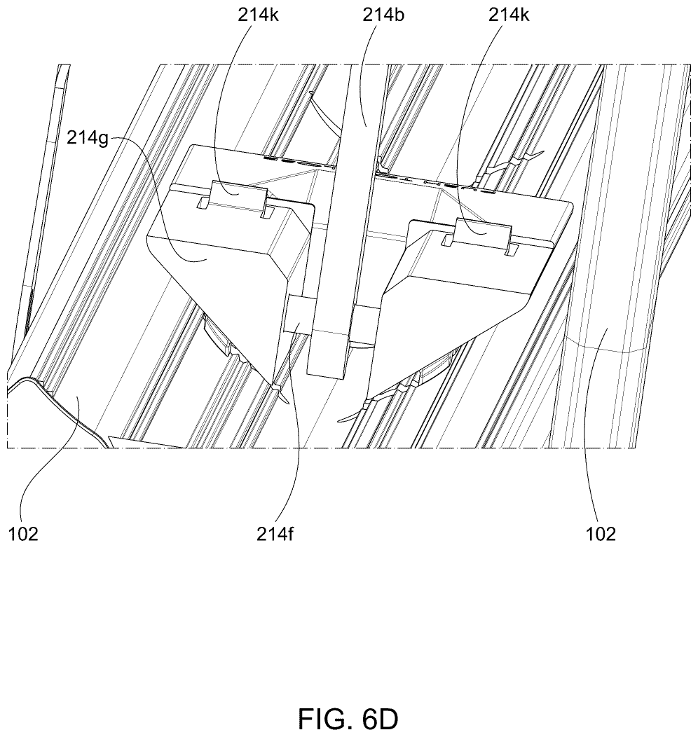

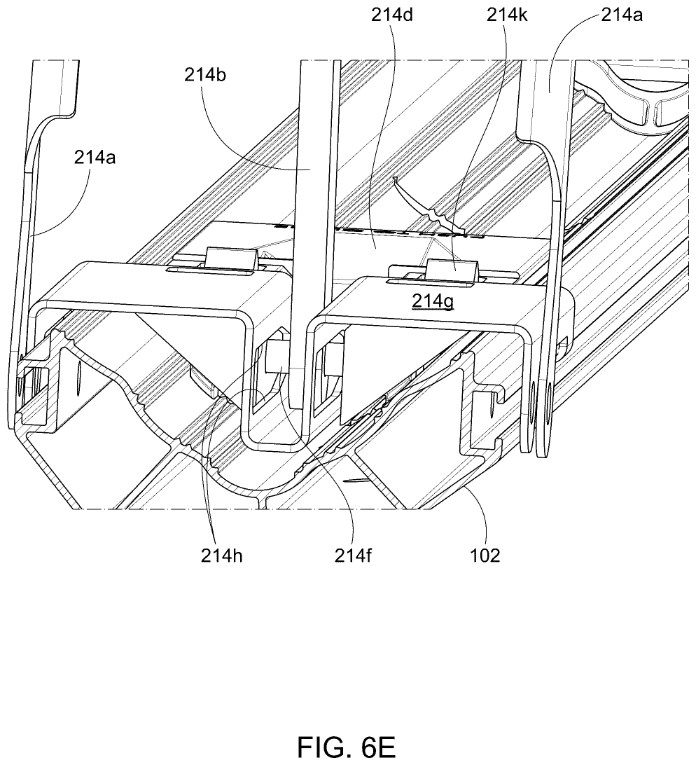

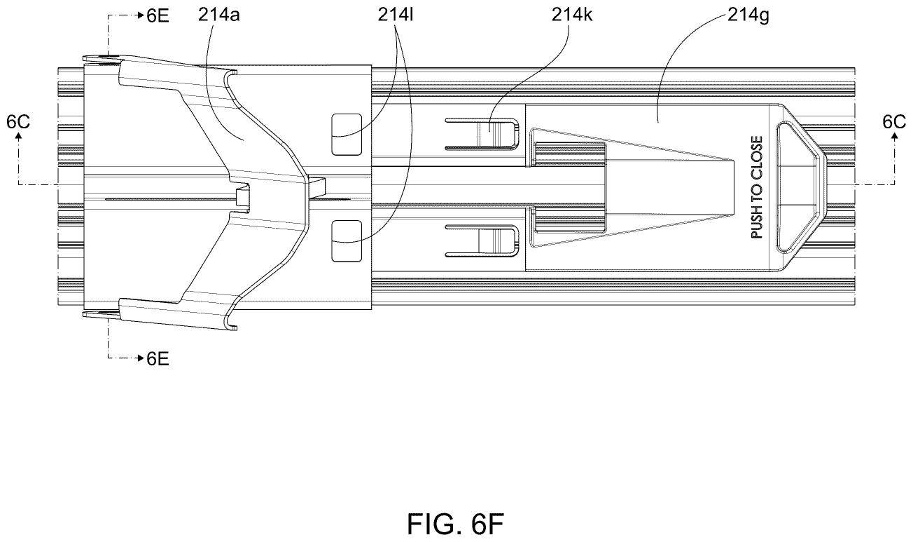

FIGS. 5A and 6A depict another embodiment of the back-side tire chock 214 in the stowed configuration, and FIGS. 5B and 6B depict this embodiment in the deployed configuration. This embodiment works similarly to the embodiment shown in FIGS. 4A through 4D, however it is also provided with a stowing handle 214d. This component allows a user to safely move the tire chock 214a from the deployed position to the stowed configuration without potential finger injury. The user may push on one end of the stowing handle to slide it along the tire platform 102. The stowing handle 214d is connected to the support arm 214b or to bearing pin 214f so that sliding the handle 214d to the left in FIGS. 5B and 6B will translate the lower end of support arm 214b to the stowed position of FIGS. 5A/6A. FIG. 6C depicts a cross-sectional view of this embodiment in a partially deployed configuration. In this view the support arm 214b has not fully moved to the deployed position when the bearing pin 214f will be at the right end of slot 214h. The slot 214h in this embodiment tapers toward one end to more firmly hold the support arm 214b and tire chock 214a in the deployed configuration.

FIG. 6D depicts the same configuration as FIGS. 5B and 6B, but the tire chock 214a and base member 214g have been removed for more clearly viewing the stowing handle 214d. In this embodiment the bearing pin 214f is connected to or in contact with stowing handle 214d so that the handle 214d can urge the pin 214f toward the stowed configuration. FIG. 6E depicts a cross-sectional view where the disposition of the bearing pin 214f through slot 214h into contact with stowing handle 214d can be seen. Base member 214g in this embodiment is fixed to platform 102 while handle 214d translates with respect to the platform 102 and base member 214g from the deployed to stowed configurations and vice versa. FIG. 6F is a top view of a portion of an embodiment of the back-side tire chock assembly 214 on a portion of a platform 102. The planes of the cross-sectional views of FIGS. 6C and 6E are indicated for reference.

In the embodiment shown in FIGS. 5A through 6F inclusive, the stowing handle 214g is provided with optional retaining members 214k that engage apertures 2141 in the stowed configuration to hold the handle 214g in the stowed position. In this embodiment the retaining members 214k are protrusions on flexible tabs that can be pushed down as they pass under the base member 214g and then pop up in apertures 2141. In other embodiments other types of clips or retaining devices may be used to retain the handle 214g in the stowed position once a user places it there. In FIG. 6E the pivot pin 214f is not depicted but the apertures for receiving the pin are visible in the components 214a and 214g and in the t-channel on the side of the platform.

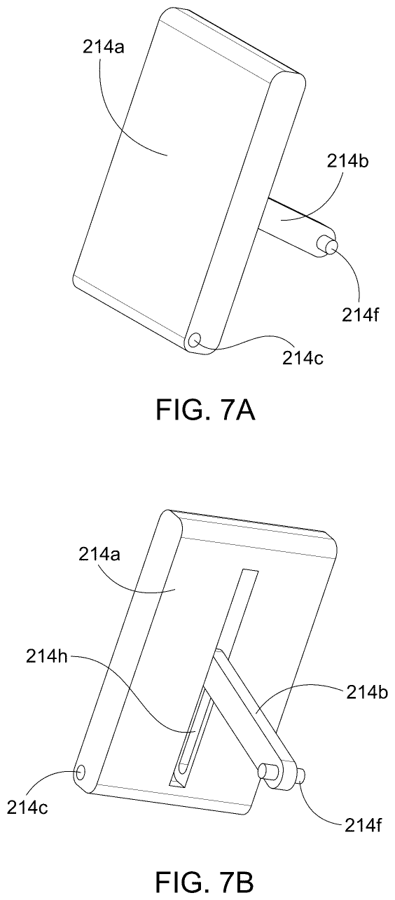

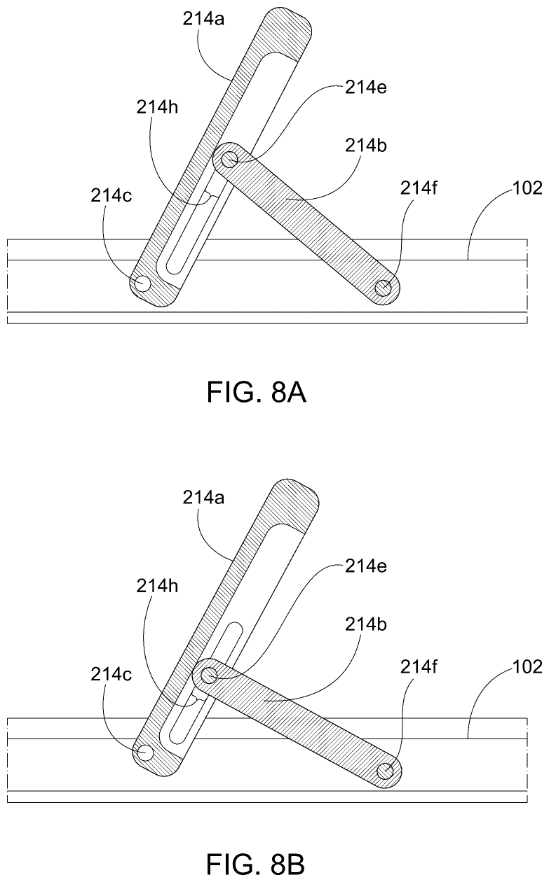

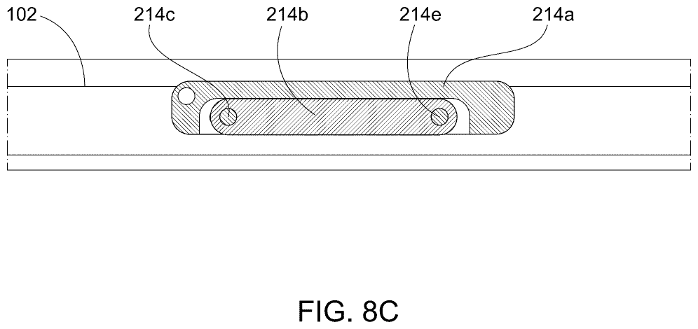

FIGS. 7A through 8C depict the tire chock in an additional embodiment of the inventive tire carrier 100. FIGS. 7A and 7B respectively depict front and back perspective views of the tire chock member 214a and support arm/member 214b removed from the bicycle carrier 100. The two components are shown in FIGS. 7A and 7B in the open or deployed configuration. In this embodiment the tire chock member 214a has a pivot axis 214c that may be an aperture that receives a pivot pin or bolt, or may comprise a bolt or pin that extends outwardly from the tire chock member 214a to engage an aperture on the bicycle carrier 100. Various embodiments may have varying pivot mechanisms at 214c in addition to those described herein. In this embodiment the support arm 214b has pivotal connections at either end. Pivot axis 214f in this embodiment is pivotally mounted to the bicycle carrier 100 at a fixed location, in contract to the prior embodiment in which the pivotal attachment at 214f slides with respect to the bicycle carrier 100. In this embodiment the other end 214e of the support arm 214b is pivotally attached to the tire chock member 214a but the pivotal attachment point slides with respect to the tire chock member 214a in slot 214h.

The function of the two embodiments is similar with the distinction that the sliding pivot is tire chock member 214a in this additional embodiment, while in the first embodiment the slot is in a member fixed to the bicycle carrier 100 on a tire platform 102. In this additional embodiment the slot 214h is in a gap, slot, or recess in the center portion of the tire chock member 214a however in other embodiments the slot 214h may be in one or both side edges of the tire chock member 214a.

FIGS. 8A, 8B, and 8C depict side cross-sectional views of the additional embodiment on an axis comparable to axis 6C shown on FIG. 6F. FIG. 8A depicts an open/deployed configuration, FIG. 8B depicts a partially open or partially closed configuration, and FIG. 8C depicts a closed/stowed configuration. In this embodiment the slot 214h is disposed in a slot or groove in the tire chock member 214a.

Similar to the first embodiment, in the deployed configuration shown in FIG. 8A, pressure from a bicycle tire against tire chock member 214a will push it against support arm 214b which will wedge even more securely against the upper end of slot 214h. When a user wants to stow the tire chock, the support arm 214b is pivoted downward toward the position shown in FIG. 8B where the arm 214b is perpendicular to the tire chock member 214a. This perpendicular configuration may be referred to as the “center” and when the support arm 214b is past this point toward the deployed configuration is “over-center”. After that point downward pressure on the tire chock member 214a will push the support arm 214b down to the stowed position of FIG. 8C, while above that point pressure on the tire chock member 214a will push the support arm 214b up to the deployed position of FIG. 8A.

In some embodiments of this additional slot position, the support arm 214b may fit completely or partially into the aperture, slot or recess in the tire chock member in the stowed configuration. This is depicted in FIG. 8C and provides for a lower profile for the stowed tire chock assembly.

In some of these embodiments a biasing mechanism 214j may be provided at pivot axis 214f or elsewhere to urge the support arm 214b toward and through the “center” position to an “over-center” deployed position. In some embodiments the biasing mechanism is a coil spring, a torsion spring, or other suitable type of mechanism for applying a biasing force to the support arm 214b.

The following item lists A, B, C, etc. are illustrative, but not limiting, of embodiments of the inventive device. Features of the following item lists may constitute features of the other item lists. The reference numbers provided in the item descriptions are for ease of reference to the figures and shall not be construed as limiting their subject matter.

A1. A bicycle carrier comprising: a platform configured to support a bicycle tire; a wheel securement arm pivotally attached to the platform; a back-side tire chock assembly disposed on the tire platform, the back-side tire chock assembly comprising a tire chock member and a support arm; and a guide slot fixed in relation to the tire platform; wherein the tire chock member is pivotally attached to the tire platform; wherein a first end of the support arm is pivotally attached to the tire chock member, and a second end of the support arm is slidably captured in the guide slot between a deployed configuration and a stowed configuration; and wherein the biasing mechanism is.

A2. The bicycle carrier according to any of the other A items, further comprising a biasing mechanism configured to translate the support arm to the deployed position.

A3. The bicycle carrier according to any of the other A items, wherein the support arm, the tire platform, and the platform form an acute triangle in the deployed configuration.

A4. The bicycle carrier according to any of the other A items, wherein the biasing mechanism comprises a torsion spring.

A5. The bicycle carrier according to any of the other A items, further comprising a stowing handle in contact with the support arm and slidably disposed on the platform.

A6. The bicycle carrier according to any of the other A items, wherein second end of the support arm contacts an end of the guide slot in the deployed configuration.

B1. A bicycle carrier comprising a tire platform, a wheel securement arm with a linear rack thereon, and a support arm assembly; the support arm assembly comprising a sliding member slidably disposed on the wheel securement arm, a support arm pivotally attached at opposing ends to the sliding member and the tire platform, and a latch mechanism disposed on the sliding member and configured to selectively engage the linear rack on the wheel securement arm.

B2. The bicycle carrier according to any of the other B items, wherein the linear rack comprises a plurality of indentations in the wheel securement arm.

B3. The bicycle carrier according to any of the other B items, wherein the latch mechanism comprises an actuator having at least one pawl in contact with the linear rack.

B4. The bicycle carrier according to any of the other B items, further comprising a biasing mechanism configured to engage the latch mechanism with the linear rack.

B5. The bicycle carrier according to any of the other B items, wherein the biasing mechanism comprises a compression spring configured to urge the pawl of the latch mechanism with the linear rack of the wheel securement arm.

C1. A bicycle carrier comprising a platform member for supporting a bicycle tire and a ramp accessory configured to releasably connect to the platform member, wherein the platform member comprises an internal storage cavity configured to receive the ramp accessory.

C2. The bicycle carrier according to any of the other C items, the ramp accessory further comprising a latch mechanism and a handle at a first end of the ramp accessory.

C3. The bicycle carrier according to any of the other C items, wherein a first end of the platform member comprises a ramp attachment point configured to accept a protrusion on a second end of the ramp accessory.

C4. The bicycle carrier according to any of the other C items, wherein the protrusion comprises an arcuate member.

C5. The bicycle carrier according to any of the other C items, wherein the ramp attachment point comprises a curved cavity for receiving the protrusion on the ramp accessory.

C6. The bicycle carrier according to any of the other C items, wherein the ramp accessory further comprises a latch member configured to engage a latch feature of the internal storage cavity.

C7. The bicycle carrier according to any of the other C items, wherein the latch member comprises a flexible member with a protrusion configured to engage the feature of the latch feature of the internal storage cavity.

C8. The bicycle carrier according to any of the other C items, wherein the latch feature of the internal storage cavity is an edge of an aperture.

“Substantially”, “approximately”, or “about” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder. The terms “about” or “substantially” or “approximately” as used herein indicates the value of a given quantity that can vary based on a particular technology. Based on the particular technology, the term “about” or “substantially” or “approximately” can indicate a value of a given quantity that varies within, for example, 1-15% of the value (e.g., ±1%, ±2%, ±5%, ±10%, or ±15% of the value).

“Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

Aspects of the present disclosure are described in detail with reference to aspects thereof as illustrated in the accompanying drawings. References to “one aspect,” “an aspect,” “some aspects,” “an embodiment”, “varying embodiments”, etc., indicate that the aspect(s) described may include a particular feature, structure, or characteristic, but every aspect or embodiment may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

Spatially relative terms, such as “beneath,” “below,” “lower,” “above,” “on,” “upper,” “opposite” and the like, may be used herein for ease of description to describe one element or feature's relationship to another element(s) or feature(s) as illustrated in the figures. The spatially relative terms are intended to encompass different orientations of the device in use or in operation in addition to the orientation depicted in the figures. The apparatus may be otherwise oriented (e.g., rotated 90 degrees or at other orientations) and the spatially relative descriptors used herein may likewise be interpreted accordingly.

1. A bicycle carrier comprising:
a platform configured to support a bicycle tire;
a wheel securement arm pivotally attached to the platform, wherein a portion of the wheel securement arm comprises a ratchet rack;
a support arm pivotally connected at a first end thereof to the platform,
a latch body slidably disposed on the wheel securement arm;
a ratchet pawl pivotally disposed on the latch body and configured to engage the ratchet rack to prevent translation of the latch body on the wheel securement arm in a first direction;
wherein the support arm is pivotally connected at a second end thereof to the latch body.

2. The bicycle carrier of claim 1 wherein the ratchet rack comprises a plurality of indentations formed in the body of the wheel securement arm.

3. The bicycle carrier of claim 1 further comprising a trigger attached to the ratchet pawl, the trigger configured to disengage the ratchet pawl from the ratchet rack.

4. The bicycle carrier of claim 3 wherein the trigger is pivotally attached to the latch body.

5. The bicycle carrier of claim 3 wherein the latch body further comprises a handle portion configured to be gripped by a user.

6. The bicycle carrier of claim 5 wherein the trigger pivots to a position adjacent to the handle to disengage the ratchet pawl from the ratchet rack.

7. The bicycle carrier of claim 4 wherein the trigger further comprises a handle portion configured to be gripped by a user.

8. The bicycle carrier of claim 3 wherein sliding the latch body in the first direction pivots the wheel securement arm to an open position for receiving a bicycle tire.

9. The bicycle carrier of claim 8 wherein sliding the latch body in a direction opposite the first direction pivots the wheel securement arm to a closed position adjacent to the platform.

10. The bicycle carrier of claim 9 wherein the first direction is oriented along the length of the wheel securement arm extending toward the attachment of the wheel securement arm to the platform.

11. The bicycle carrier of claim 9 wherein the ratchet rack extends along the wheel securement arm to engage the ratchet pawl when the wheel securement arm is in both the open position and the closed position.
